(19) United States
(12) Patent Application Publication
(10) Pub. No.: US 2013/0076482 A1
(43) Pub. Date: Mar. 28, 2013

(54) SECURE ACCESS SYSTEM EMPLOYING BIOMETRIC IDENTIFICATION

(71) Applicant: Wah Tong Thomas Wan, Tradehub (SG)

(72) Inventor: Wah Tong Thomas Wan, Tradehub (SG)

(73) Assignee: ACTATEK PTE LTD, Tradehub 21 (SG)

(21) Appl. No.: 13/703,245

(22) PCT Filed: Jun. 9, 2010
(86) PCT No.: PCT/SG2010/000217

§ 371 Date: Dec. 10, 2012

(51) Int. Cl. G05B 1/01

(52) U.S. Cl. CPC G05B 1/01
USPC 340/5.3; 340/5.52

(57) ABSTRACT

A secure access system includes security stations 2 which grant access to doors 3 under the control of a computer 1. The security stations 2 include biometric sensors 212 which receive biometric data from users, and transmit it to the computer 1. The computer 1 matches the received biometric data to stored biometric data, to identify the user, and so control the security station 2 to grant access to the door 3. A display system 4 is used to display any stored message for the user. For each of the users, the system stores security data for one or more associated security cards, which may be attached to valuable properties. A wireless system 7 monitors whether any of the security tokens leaves a secure area. If this happens without the presence of the associated user having been detected by the biometric system, an alarm protocol is performed. In a variant of this procedure, a user is required to provide both (i) biometric data and (ii) a password and/or RFID card to access a secure computer network environment.

### FIELD OF THE INVENTION

The present invention relates to a secure access system which includes biometric identification.

### BACKGROUND OF THE INVENTION

It is well known to provide access to a secure facility using a door equipped with a lock mechanism under the control of a security device. The security device may, for example, be a keypad for receiving a secret passcode. The passcode is compared with a list of one or more passcodes stored in a memory (either located within the security device, or at a remote computer which is in communication with the security device) and in case of a match, the security device controls the lock mechanism to enable the door to be opened. Instead of a keypad, it is known to provide a biometric sensor, such as a finger- or hand-print sensor, or a camera, which may be a still camera or video-camera, for capturing imaging from which a user's identity can be automatically identified. Alternatively, it is known to provide an RFID contact or contact-less card, or other wireless token to be carried by the user. The RFID tag can be a “smart card” which means that it includes memory and/or a CPU, so that can receive data and store it and/or process it. Such cards exist in both contact (i.e. physical contact with a smart card reader is required) and contactless forms. The RFID cards can alternatively be less sophisticated cards which to which data cannot be written. These are referred to here as tags, and may be “active” (which means it includes a battery to power the RFID card, and can operate over a long distance) or “passive” (without a battery and short distance). Data captured by the biometric sensor and/or camera and/or from the wireless token is compared with a library (again stored in the security device itself of the remote computer), and in case of a match, the security device controls the lock mechanism to permit the door to be opened. Some locations provide multiple independent security systems, in which the user is authenticated (e.g. in respect of different parts of the location) using RFIDs cards, PINs or biometrically.

### SUMMARY OF THE INVENTION

The present invention aims to provide a new and useful secure access system.

In general terms, the invention proposes that a secure access system includes:
a first security data collection device (e.g. a biometric data collection device) for receiving first security data (e.g. biometric data),
a second data collection device for receiving additional security data, and
a comparison unit for assessing whether the received first security data and additional security data both correspond to stored first security data and predetermined additional data associated with any one of a predetermined set of users, and implementing a security protocol accordingly. In other words, the security protocol is implemented depending upon whether the received biometric data and additional data are both matched with the same one of the set of users.

The comparison unit may be implemented by software running on a central computer of the secure access system, and referring to a database in the computer storing the stored first security and predetermined additional security data. Alternatively it may be implemented by software running at a security station located near one of the doors, making use of a database there of the predetermined biometric and additional security data. In some embodiments, if no match is found using a comparison unit at the security station, then the stored first security data (e.g. biometric data) and additional security data are transmitted to a central computer where a second comparison unit tries again to find a match, using either a different comparison algorithm and/or a more comprehensive database. Thus, from one point of view there are multiple comparison units (at the security stations and the computer), while from another point of view there is a single, distributed comparison unit.

In a first example, the second data collection device is a wireless data collection device, and the additional security data is security data received from a wireless security token, such as RFID data from a RFID card (which may be a smart card, or an active or passive tag). One or more of the security tokens are associated with each of the users. The security tokens may be physically connected to (e.g. provided within) valuable items (“properties”), such as portable computers, mass data storage devices carrying sensitive data, or objects with high financial value such as jewelry.

Suppose that a certain one of the properties is within a secure area. The wireless data collection device may be located at an entry point to a secure area (so that it can establish whether the object enters or leaves the secure area), or may be able to detect the presence of the security tokens within the secure area. The security protocol may include an alarm sequence (e.g. sounding an audio alarm, sending a warning message to the associated user, or to security guards, etc) if the object is removed from the secure area. However, if the associated user provides biometric security data to the biometric data collection device, then the object may be removed from the secure area without the alarm sequence being triggered. If the departure of the user from the secure area is established (e.g. again using the biometric data) without the associated security token(s) being removed, then the alarm system is reactivated, so that if the object is removed from the secure area later the alarm sequence is performed.

It is preferred that the first security data is biometric data, but it may other alternatives are possible, such as data from an RFID card, especially RFID smart card (in which case the first data collection device is an RFID smart card reader). The RFID smart card may be of the contact or contactless forms, and may itself store include PIN and biometric data. Even in systems in which the first security collection device is a biometrics collection device, it is preferred that a RFID smart card reader is provided also, either to give additional level of security (i.e. so that access is granted only if both the biometrics and RFID smart card authentications are successful), or alternatively to provide a back-up form of authentication in the case that the biometrics authentication is unsuccessful.

In another form of the invention, the first security data is biometric data, the additional security data is a password and/or data read from an RFID card (or other security token), and the security protocol comprises granting or refusing access to a secure computer network environment. For example, the second data collection device may be a keypad of the terminal for receiving the additional data in the form of password data. In this case, a computer permits access to a secure computer network environment only if a comparison unit (located at the terminal or at the computer) determines that (i) the additional security data collected by the second data collection device matches predetermined network security data (e.g. a network password) for a given user, and if (ii) the received biometric data matches the same user. This makes access to the computer network environment more secure than in existing systems, which are reliant only on a single form of user identification.

Preferably, the security access system includes a message database for storing messages associated with one of more of the users. When the user enters biometric data to a biometric data collection device, and the biometric security system authenticates the user, to grant access to a secure area, the security access system extracts any data corresponding to that user from the message database, and displays that message to the user. The display is typically visual, but the message may include associated sound which is broadcast to the user. More generally, the message itself can be text, audio, still picture or video. It can be advertising, e.g. advertising which is targeted at the identified user.

In either aspect of the invention, the biometric data collection device may be a finger- or hand-print, or vein- or sub-veinous, or iris or facial (or other anatomical) sensor; or indeed any other form of biometric sensor.

The security system may optionally contain other data collection devices which are used in determining whether an access event has occurred and/or whether to permit access to a secure area. These devices may include any of a keypad, an audio sensor, a heat sensor, a humidity sensor, a vibration sensor, a shock sensor, and a smoke sensor, or indeed any other suitable sensor. It may further include a still camera and/or a video camera for capturing an image of the user. The keypad and or the camera(s) may be operative in the case that biometric identification fails, so that an alternative authorization procedure can be carried out, based on a code entered into the keypad and/or the captured still or video images.

The invention may be expressed in terms of a system (that is an apparatus), or alternatively as the method carried out by the comparison unit of such a system.

### BRIEF DESCRIPTION OF THE FIGURES

Embodiments of the invention will now be described for the sake of example only with reference to the accompanying drawings, in which:

FIG. 1 is a schematic view of a secure access system which is a first embodiment of the invention;

FIG. 2, which is composed of FIGS. 2(a) and 2(b), shows the structure of part of the database within a security station and/or within a computer of the embodiment of FIG. 1;

FIG. 3 is a schematic view of a secure access system which is a second embodiment of the invention; and

FIG. 4 shows the structure of a part of a database of the embodiment of FIG. 3.

### DETAILED DESCRIPTION OF THE EMBODIMENTS

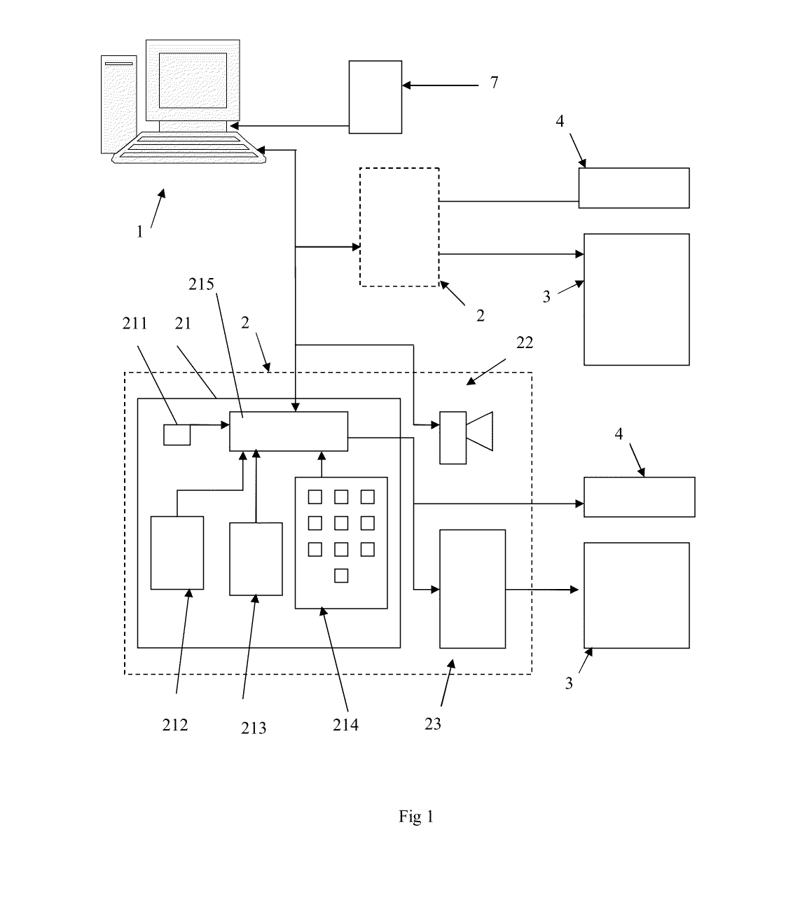

Referring to FIG. 1, a first embodiment of the invention is illustrated. The embodiment is a secure access system which includes a computer 1 and a plurality of security stations 2. Two security stations 2 are shown, but there may be any number (for example, just one). The security stations 2 are associated with respective doors 3 to a secure area, and with respective display systems 4 near the doors. The computer 1 is connected over a communication network (which may include tangible communication channels such as wires and/or wireless communication channels) to the plurality of security stations 2. Security stations 2 may optionally be provided on both sides of a given door, so as to permit both egress and ingress to the secure area through the door.

The security stations 2 may have identical construction. The internal structure of one of the security stations 2 is shown. The security station 2 includes a security device 21 for controlling a lock device 23. The security device 21 further includes a biometric sensor 212. The biometric sensor 212 may be a finger- or hand-print, or vein- or sub-veinous, iris or facial or any other form of biometrics sensor.

Optionally, the security device 21 further includes a video camera 22, arranged so that its field of view includes a location proximate or including the corresponding security device 21 and/or the corresponding door 3. Conceivably a single video camera 22 might be shared by multiple ones of the security stations 2, if those security stations 2 happen to be close to each other. The security device 21 optionally further includes a still camera 211 for taking a still picture of a user interacting with the security device 21. The camera 211 is shown as internal to the security device but it may alternatively be external. Particularly if it is external, it may include a data storage device. The security device 21 optionally further includes a keypad 214 for registering key-presses made by a user. The keypad may have any number of keys, for example 10 keys corresponding to the digits 0 to 9, or even be a full QUERTY keyboard.

The camera 211, biometrics sensor 212, RFID card reader 213 (particularly an RFID smart card reader) and keypad 214 are arranged to transmit the data they register to a control device 215 which is in two-way communication with the computer 1. The control device 215 is arranged to control the corresponding lock device 23, so as to grant access to a secure area via the corresponding door 3. Optionally, the security device may include any one or more additional sensors (not shown) such as: an audio sensor, a heat sensor, a humidity sensor, a vibration sensor, a shock sensor, a smoke sensor, etc.

A user accesses the secure region via the door 3 by interacting with the security device 21 in an “access event”. During this process the control device 215 registers data transmitted by the user to the control device 215 using the biometric sensor 212.

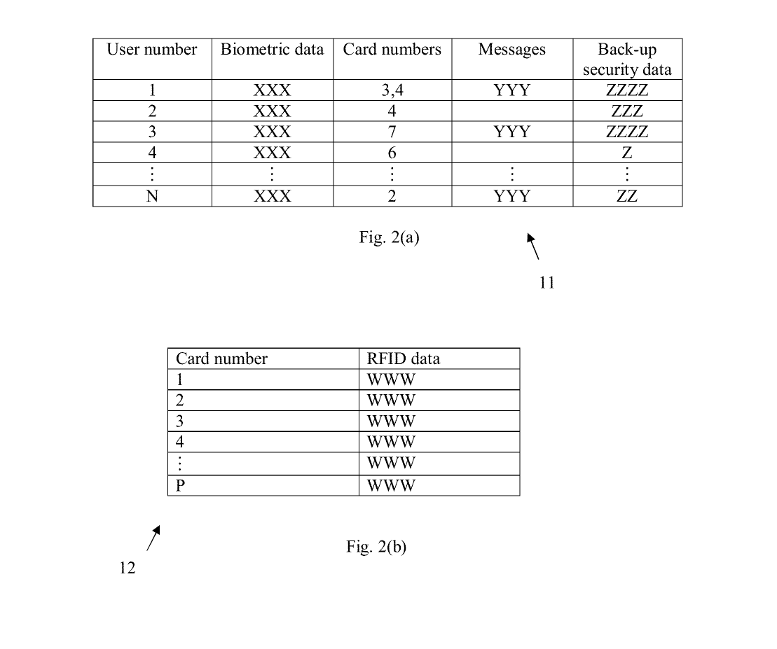

The control device 215 employs a database with two portions 11, 12 with respective structures shown in FIGS. 2(a) and 2(b). Turning first to database portion 11, for each of a set of N users (numbered 1, . . . , N) the database stores corresponding biometric data shown as XXX (although, of course, it is different for each user).

As described in more detail below, the system employs a number P of security tokens (not shown), such as RFID cards. The P RFID cards are physically attached or within “properties”, which are objects considered valuable for any reason (e.g. intrinsic value, or due to data they carry). For one or more of the users, the database portion 11 further includes a list of one or more “card numbers”. Each card number is the number of one of the P cards. The database portion 11 indicates that one or more of the P cards associated with each user. For example, the user with user number 1 is shown by FIG. 2(a) as associated with card numbers 3 and 4. It is preferred that the RFID cards are smart cards (contact or contactless) and may themselves encode PIN and/or biometrics data.

For one of more of the users, the database portion 11 also stores corresponding message data, shown as YYY. For example, such a message is shown for users 1, 3 and N, but not for users 2 or 4.

Optionally (particularly in the case that security device 21 includes a video camera 22, a still camera 211, an RFID token reader 213, or a keypad 214) the database portion 11 further stores for one of more of the users additional security data (shown as ZZZ). This data is used in the case that the biometric identification fails for some reason, and an alternative method of identification of a user is required. In this case, the user may for example use an RFID card carried by the user (this is not one of the P RFID cards which are listed in the column “card numbers” in database portion 11) to identify himself, perhaps in combination with entering a passcode using the keypad 214. The data ZZZ in this case includes the data to be received from the RFID card carried by the user, and the passcode.

Upon receiving the biometric data, the control device 215 is enabled to compare the received biometric data with the biometric data XXX stored in the database portion 11. Upon detecting a match, the control device 215 recognizes the presence of the corresponding user at the security station 2. The control device 215 operates the lock device 23 to unlock the door 3. The control device 215 may then send a message to the computer 1 to notify the computer 1 that the control device 215 has recognized the presence of a user by this biometric process. The message indicates which user has been recognized.

If the database portion 11 further contains a message for the recognized user, the control device 215 further extracts the message data YYY, and controls the corresponding display system 4 to display the message. The message may be a security alert, for example, but may alternatively be an advertising message. The message may be in the form of visual information and/or audio information. The term “display” is used here to include the case of generating sound only. In some forms of the embodiment, the “display” systems 4 may only be operative to display a visual message, or only operative to generate sound based on the message, but more preferably the display systems 4 are capable of display both sound and images.

Although the explanation above involves the control device 215 acting as a comparison unit to find a match between received biometric data and predetermined biometric data in the database portion 11, the database 11 may alternatively be stored in the computer 1. In this case, the control device transmits the received biometric data to the computer 1 where the comparison is done, and the results of the comparison are transmitted back to the control device 215, to control the lock device 23 accordingly. In another possibility, the database (or at least parts of it) may be duplicated at the control device 215 and the computer 1. If the control device 215 fails to match received biometric data with stored data, it may transmit the received biometric data to the computer 1, which repeats the comparison exercise using its own database of stored biometric data, and possibly with a different algorithm, and if there is a match informs the control device 215 accordingly. Thus, from one point of view there are multiple comparison units, or from another point of view a single distributed comparison unit.

Similarly, the messages may be stored at the control device 215 (as explained above) and/or at the central computer 1. In the latter case, the messages are transmitted from the computer 1 to the security station 1 upon it being recognized (e.g. by the computer 1, or by the control device 215 which sends a message to the computer 1) that the corresponding user is present at the security station 2.

The computer 1 is connected to a reader device 7 for communicating wirelessly with any security token which is anywhere within a secure area, and in particular receiving security data from the security token. In one variation, there may be multiple reader devices 7 collectively covering the secure area, each of the reader devices 7 communicating with any security token within a respective portion of the secure area.

The reader 7 wirelessly receives security data (e.g. periodically) from the cards within the secure area, and sends it to the computer 1. The computer 1 accesses database portion 12. For each of the P cards, the database portion 12 stores the corresponding security data. This data is denoted WWW. This data WWW is different for each of the cards. The sever 1 is thus able to identify the corresponding card numbers from the security data it receives from the reader 7, and maintains a list of the cards which are within the secure area.

Upon the computer 1 recognizing one of the users by the biometric process described above, or being sent a message by the control unit 215 that the control unit 215 has recognized a certain user by the biometric process described above, the computer 1 uses database portion 11 to identify the associated RFID cards. For example, if the computer 1 has recognized that user number 1 is at the security station 2, then the computer 1 identifies that the user associated with card numbers 3 and 4 has entered the secure area. In these circumstances, if either of card numbers 3 or 4 is subsequently removed from the secure area (that is, the reader 7 no longer recognizes the presence of card number 7), no alarm protocol is commenced.

Conversely, if the reader 7 stops receiving security data from card number 3 or 4, but the computer 1 has not received biometric data from user number 1, an alarm protocol is activated, since this indicates that the property associated with card number 3 or 4 is being removed from the premises without the associated user. The alarm protocol may include sounding an alarm, and/or sending a message to a security professional and/or to the user 1—that is, the user identified by the database portion 11 as associated with the RFID card which is being removed.

In other words, the secure access system is alert to any of the RFID cards being removed from the secure area. If the user associated with any property enters the secure area, the alarm in respect of the associated RFID card is disabled, in the sense that the RFID card can then be removed from the secure area without the alarm protocol being activated. However, if the user leaves the secure area without removing the associated RFID card (e.g. by interacting again with any of the secure stations 2 by the same process described above), then the alarm in respect of that property is reactivated.

Several variations of the above scheme are possible within the scope of the invention. For example, instead of, or in addition to, reader device(s) 7 which are (collectively) able to detect the presence of tokens within the secure area, the reader devices 215 at the secure stations 2 may be used. That is, the secure station 2 is able to detect when one of the P security cards passes nearby one of the secure stations 2, and transmit that information to the computer 1. This possibility may be more suitable if the RFID cards are passive tags. The alarm protocol may be activated if the computer 1 is notified that one of the security cards approaches one of the security stations, but the computer 1 does not receive (e.g. within a predetermined time before or afterwards) biometric date of the user associated with that security token.

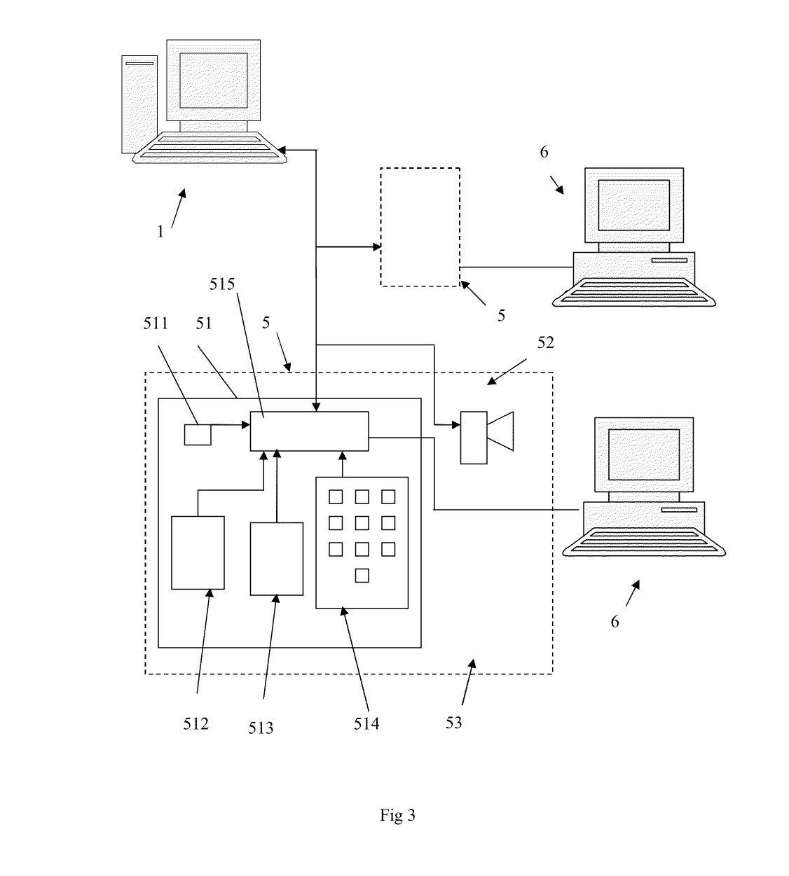

We now turn to a second embodiment of the invention which is shown in FIG. 3. Whereas in the first embodiment, the security stations 2 were associated with doors 3, in the second embodiment the computer 1 communicates with security stations 5 associated with terminals 6. The construction of the security station 5 is similar to the security station 2 of FIG. 1, and corresponding elements are illustrated in FIG. 3 by reference numerals in which the first digit of FIG. 1 is replaced by 5. In particular, the security station 5 includes a biometric sensor 512 for receiving biometric data, and transmitting it via a control device 515 to the computer 1.

In this embodiment, the computer 1 is a gate for a secure computer network environment. A user who wishes to access the secure computer network environment has to identify himself or herself in two ways: by inputting biometric data to the biometric sensor 512, and by entering additional security information (e.g. password information and/or data from an RFID card) to the associated terminal 6.

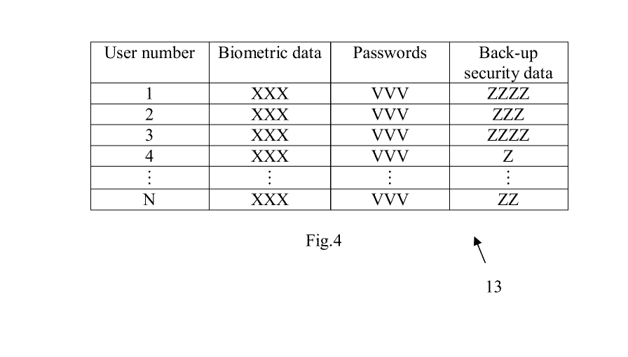

The system maintains, for each of the users, a database portion 13, as illustrated in FIG. 4. The database portion 13 may be stored at each of the terminals 6 and/or at the computer 1 (in which case the terminals 6 transmit the additional security information they receive to the computer via the corresponding security station 6). The database portion 13 stores, for each of N authorized users of the secure computer network, indentified by a user number, a corresponding set of biometric data (indicated as XXX) and corresponding additional network security data (indicated as VVV) which may be a network password and/or security data from a security card (e.g. RFID card, such as an RFID smart card or RFID tag) carried by the user. The computer 1 gives access to the secure computer network environment if, and only if, a comparison unit at the computer 1 and/or the terminal 6 determines that the biometric sensor 512 has received biometric data identifying a certain user, and the corresponding terminal 6 has received additional security data which, according to the database portion 14, matches the stored network security data. For example, if the stored network security data is a network password, the terminal 6 must receive a network password associated with the same user. In other words, a user is only granted access to the secure computer network environment is he or she can supply adequate biometric data and the required additional security data which may be either (or in other embodiments both) of a password or a data from a security token carried by the user.

As in the first embodiment, the database portion 13 optionally contains additional security data (labeled as ZZZ) which may be used as a back-up in the case the biometric identification fails. XXX, VVV and ZZZ are different for each of the N users.

In a variation of the second embodiment, one of the biometric sensors 512 may be shared between multiple ones of the terminals 6, such that access to the secure computer network environment is granted to a user who enters biometric data to that biometric sensor 512 and enters the password into any of the multiple terminals 6 which share that biometric sensor.

The first and second embodiments may be combined. That is, a single computer 1 may be provided with security stations 2 associated with doors 3 and display systems 4, and with security stations 5 associated with terminals 6. The terminals 6 may be within the secure area to which access is gained by the doors 3.

In this case, optionally there may be no biometric sensors 512 associated with the terminals. Instead, the computer 1 may alerted to the presence of one of the set of users within the secure area by the user transmitting biometric data to the biometric sensor 212 of the security station, and the computer 1 then grants access to the secure computer network environment whenever the network password for the same user is entered into one of the terminals 6. In other words, the biometric sensors 212 of the security stations 2 replace the need for additional biometric sensors 512 associated with the terminals 6.

1. A secure access system comprising:
one or more lock devices for granting access to a secure area;
one or more security devices associated with corresponding ones of the lock devices, each security device comprising first data collection device for receiving first security data associated with users;
a wireless data collection device for receiving wireless security data from one or more security tokens within the secure area; and
at least one comparison unit arranged (i) to receive the first security data from the first data collection devices, (ii) to access a database which stores first stored security data for each of a set of users, (iii) to match the received first security data with the first stored security data stored in the database, to recognize the presence one of the set of users, and (iv) accordingly control the corresponding lock device;
the database additionally storing data which associates each of a set of users with one or more of the security tokens,
the comparison unit being further arranged, upon one of the security tokens leaving the secure area, (v) to determine, based on the received wireless security data, the identify of the security token which is leaving the secure area, and (vi) to activate an alarm protocol if the computer does not recognize the presence of the associated user.

2. A secure access system according to claim 1 in which the first data collection device is a biometric data collection device, and the first security data and the first stored security data stored in the database are biometric data.

3. A secure access system according to claim 1 in which a respective comparison unit is associated with each of the security devices.

4. A secure access system according to claim 1 or claim 3 in which a comparison unit is provided at a computer, the computer being in communication with each of the security devices.

5. A secure access system according to claim 1 in which the database further includes a data space for storing messages, each message being associated with one or more of the set of users,
the computer being arranged, upon recognizing the presence of one of the set of users, to extract a stored message associated with that user, and to transmit that message to a display device for displaying the message to that user.

6. A secure access system according to claim 1, further including a database which stores predetermined network security data for each of the users,
the secure access system further including one or more terminals connected to the computer and arranged to receive additional security data and to transmit received additional security data to an additional comparison unit with access to the database of predetermined network security data,
the additional comparison unit being arranged to compare additional security data received from one of the terminals with the predetermined network security data stored in the database, and to grant access to a secure computer network environment only upon the additional security data received by the terminal matching the predetermined network security data of a user whose presence has been recognized.

7. A secure access system according to claim 6 in which the network security data comprises a network password.

8. A secure access system comprising:
one or more biometric data collection devices for receiving biometric data;
at least one comparison unit arranged (i) to receive the biometric data from the biometric data collection devices, (ii) to access a database which stores biometric data for each of a set of users, (iii) to match the received biometric data with the biometric data stored in the database, to recognize the presence one of the set of users, and
one or more terminals connected to the computer and arranged to receive additional security data and to transmit a received additional security data to the comparison unit,
the at least one comparison unit being arranged to compare the additional security data received from one of the terminals with the predetermined network security data stored in the database, and to grant access to a secure computer network environment via the terminal only upon determining that the additional security data entered into the terminal matches the stored network security data of a user whose presence has been recognized.
